(19) United States
(12) Patent Application Publication
(10) Pub. No.: US 2024/0025165 A1
(43) Pub. Date: Jan. 25, 2024

(54) LAMINATE DISPENSING DEVICE AND LAMINATE DISPENSING METHOD

(71) Applicant: TANAKA ENGINEERING CO., LTD., Toyama-shi (JP)

(72) Inventor: Eiichi KUROSAKI, Toyama-shi (JP)

(21) Appl. No.: 18/220,383

(22) Filed: Jul. 11, 2023

(30) Foreign Application Priority Data
Jul. 20, 2022 (JP) 2022-115262

(51) Int. Cl. B32B 37/00; B32B 7/12; B32B 37/12; B32B 15/01; B32B 38/18

(52) U.S. Cl. CPC B32B 37/0046; B32B 7/12; B32B 37/12; B32B 15/011; B32B 38/1841; B32B 2037/1253

(57) ABSTRACT

In FIG. 7A, thin steel sheets 17 inside a fixed squeeze 42 continue to descend. Once a thin steel sheet 17 (n) passes a lower end of a first movable squeeze 54, the first movable squeeze 54 is closed. In FIG. 7B, once the thin steel sheet 17 (n) passes a lower end of a second movable squeeze 55, the second movable squeeze 55 is closed. In FIG. 7C, a laminate 50 is dispensed from a backup 43. There is provided a laminate dispensing technique that allows the thin steel sheets inside the fixed squeeze to continue to descend even during dispensing by enabling the continuous descent of the thin steel sheets 17 inside the fixed squeeze 42 and the first movable squeeze 54 and the second movable squeeze 55 during this period.

### FIELD OF THE INVENTION

The present invention relates to a laminate dispensing technique for dispensing a laminate in which a predetermined number of thin steel sheets are laminated.

### BACKGROUND OF THE INVENTION

In the related art, a mechanism for laminating thin workpieces in a stacked state and a mechanism for dispensing a predetermined number of workpieces from the lowest position of the laminated workpieces are known. Stacking is also referred to as piling, and a predetermined number of the workpieces to be dispensed is referred to as one laminate.

A laminate dispensing device applied to such punched thin steel sheets is known, for example, as disclosed in Japanese Unexamined Patent Publication No. 2005-334893.

The technique disclosed in Japanese Unexamined Patent Publication No. 2005-334893 will be described with reference to FIG. 8A and FIG. 8B.

FIG. 8A and FIG. 8B are views describing a basic principle of the technique of the related art.

As shown in FIG. 8A, an electromagnetic steel sheet 101 is punched by a punch 102 that is raised and lowered.

Punched thin steel sheets 103 are piled up on a support table 104 in a stacked state.

A screw shaft 105 is rotated synchronously with the punching, and the support table 104 is gradually lowered.

As a result, a large number of the thin steel sheets 103 are piled on the support table 104 in a stacked state.

Japanese Unexamined Patent Publication No. 2005-334893 does not clearly state that the descent of the thin steel sheets 103 is stopped; however, immediately before a pusher 108 is moved forward, the descent of the thin steel sheets 103 is stopped. Then, a damper 107 is moved forward.

As shown in FIG. 8B, a thin steel sheet 103A (A is a subscript for specifying a location) located at a predetermined height position is clamped by the damper 107.

In this state, a laminate 109 is dispensed by the pusher 108.

As described above, the laminate 109 is dispensed from the lowest position of the large number of thin steel sheets 103 that are piled.

The pusher 108 is returned. Next, the screw shaft 105 is rotated, and the support table 104 hits the thin steel sheets 103A. Next, the damper 107 is opened.

Next, a descent of the thin steel sheets 103 is resumed, and the device returns to the state of FIG. 8A.

However, there are items requiring improvement in the technique disclosed in Japanese Unexamined Patent Publication No. 2005-334893. The items requiring improvement are listed below.

First, since the descent of the thin steel sheets 103 is stopped while the laminate 109 is dispensed by the pusher 108, productivity decreases.

In addition, as shown in FIG. 8B, since the thin steel sheet 103A is restrained by the clamper 107, there is no concern about a movement in a lateral direction. However, there is a risk that the thin steel sheets 103 existing above the thin steel sheet 103A move laterally.

However, the thin steel sheets 103 are joined by crimping, and the degree of the lateral movement is minor.

In recent years, as a method of replacing crimping, the thin steel sheets 103 are joined by an adhesive.

In the case of the adhesive, since a predetermined adhesive strength is obtained by heating (or pressing) performed after dispensing, there is a significant risk that the thin steel sheets 103 existing above the thin steel sheet 103A move laterally at the time of the dispensing.

As a countermeasure, a step of aligning the thin steel sheets is added after dispensing and before heating (or pressing).

However, when the alignment step is added, a device therefor is added, so that device costs are increased.

In recent years, amid a demand for an improvement in productivity, there is a strong demand for a laminate dispensing technique that allows the thin steel sheets inside the fixed squeeze to continue to gradually descend even during dispensing, and that eliminates concern about a lateral movement of the thin steel sheets during piling.

### SUMMARY OF THE INVENTION

An object of the invention is to provide a laminate dispensing technique that allows thin steel sheets inside a fixed squeeze to continue to gradually descend even during dispensing, and that eliminates concern about a lateral movement of the thin steel sheets during piling.

The inventors have noticed the presence of a weak joining force in an adhesive before a curing process due to a surface tension, while researching a technique for enabling a continuous descent of thin steel sheets, and have considered the possibility of achieving continuity through this notice. In order to verify the consideration, experiments were performed. Contents of the experiments will be described with reference to FIGS. 1A to 1C.

Incidentally, in the following description, when height positions of thin steel sheets 17 in a stacked state are distinguished, (1) to (n) are attached to the thin steel sheets 17 as with thin steel sheets 17 (1) and 17 (n).

Naturally, the thin steel sheet 17 (1) to the thin steel sheet 17 (n) are the same as the thin steel sheets 17.

As shown in FIG. 1A, the thin steel sheets 17 were stacked and the second thin steel sheet 17 (2) from the bottom was clamped by a damper 18. According to the experiments, the thin steel sheet 17 (1) did not fall.

A thermosetting adhesive was applied to the thin steel sheets 17. The adhesive had a surface tension (even before a curing process). It was considered that this was because a surface tension between the thin steel sheet 17 (1) and the thin steel sheet 17 (2) was larger than the dead weight of the thin steel sheet 17 (1).

As shown in FIG. 1B, the fourth thin steel sheet 17 (4) from the bottom was clamped. A load (the sum of dead weights) of the thin steel sheets 17 (1) to 17 (3) was applied between the third thin steel sheet 17 (3) from the bottom and the fourth thin steel sheet 17 (4) from the bottom. However, the thin steel sheets 17 (1) to 17 (3) did not fall.

As shown in FIG. 1C, the sixth thin steel sheet 17 (6) from the bottom was clamped. Then, the thin steel sheets 17 (1) to 17 (5) fell.

It was considered that this was because a load (the sum of dead weights) of the thin steel sheets 17 (1) to 17 (5) was larger than a surface tension between the thin steel sheet 17 (5) and the thin steel sheet 17 (6).

By the way, the thin steel sheets 17 are often mechanically joined by crimping.

In this case, a temporary crimping is performed during stacking, and a final crimping is performed in a post-process. The thin steel sheets 17 are joined by a weak force through the temporary crimping.

In FIG. 1B and FIG. 1C, the number of the thin steel sheets 17 below the damper 18 is changed by one or two, but the same results as in FIGS. 1A to 1C were obtained even by a temporary crimping.

From the above, the inventors have found that a continuous descent of the thin steel sheets 17 can be performed when dispensing is completed before reaching the state of FIG. 1C, namely, during a transition from FIG. 1A to FIG. 1B, and have come to complete the following invention based on this finding.

Namely, according to one aspect of the invention, there is provided a laminate dispensing device including: a fixed squeeze having a guide hole that accommodates thin steel sheets in a stacked state and that guides the thin steel sheets gradually descending at a low speed; a backup receiving the thin steel sheets in a stacked state; a backup lifting mechanism that switches the backup between a low speed and a high speed to raise and lower the backup; a push-out mechanism that dispenses a laminate on the backup when a predetermined number of the thin steel sheets being laminated is referred to as the laminate; and a control unit that controls the backup lifting mechanism and the push-out mechanism. The thin steel sheets are weakly joined by one of an adhesive before a curing process and a temporary crimping before a final crimping. A movable squeeze and a squeeze opening and closing mechanism that opens and closes the movable squeeze are further provided below the fixed squeeze. The movable squeeze has a lower guide hole having the same diameter as the guide hole when the movable squeeze is closed. An axial length of the movable squeeze is set to be larger than a descent distance of the thin steel sheets descending from the fixed squeeze while the laminate is dispensed. The control unit performs control to start a high-speed descent of the backup once the predetermined number of thin steel sheets on the backup pass through the fixed squeeze, to close the movable squeeze once the laminate on the backup passes through the movable squeeze, and to open the movable squeeze once the laminate is dispensed, then a high-speed rise of the backup starts, and the backup hits the thin steel sheets inside the movable squeeze.

In the invention, the movable squeeze is provided, and the movable squeeze is opened and closed by the squeeze opening and closing mechanism, so that the gradual descent operation of the thin steel sheets inside the fixed squeeze can be continued. In addition, a lateral movement of the thin steel sheets in a stacked state, namely, the thin steel sheets during piling in the guide hole of the fixed squeeze is suppressed.

Therefore, according to the invention, there is provided the laminate dispensing device that allows the thin steel sheets inside the fixed squeeze to continue to gradually descend even during dispensing, and that eliminates concern about a lateral movement of the thin steel sheets during piling.

According to one aspect of the invention, there is provided a laminate dispensing method including: preparing a plurality of thin steel sheets weakly joined by one of an adhesive before a curing process and a temporary crimping before a final crimping, a fixed squeeze having a guide hole that accommodates the thin steel sheets in a stacked state and that guides the thin steel sheets gradually descending at a low speed, a backup receiving the thin steel sheets in a stacked state, a backup lifting mechanism that switches the backup between a low speed and a high speed to raise and lower the backup, a push-out mechanism that dispenses a laminate on the backup when a predetermined number of the thin steel sheets being laminated is referred to as the laminate, a movable squeeze provided below the fixed squeeze, and a squeeze opening and closing mechanism that opens and closes the movable squeeze; and dispensing the laminate while continuing the descent of the thin steel sheets inside the fixed squeeze, by starting a high-speed descent of the backup once the predetermined number of thin steel sheets on the backup pass through the fixed squeeze, by closing the movable squeeze once the laminate on the backup passes through the movable squeeze, and by opening the movable squeeze once the laminate is dispensed, then a high-speed rise of the backup starts, and the backup hits the thin steel sheets inside the movable squeeze.

According to the invention, the gradual descent operation of the thin steel sheets inside the fixed squeeze can be continued. In addition, a lateral movement of the thin steel sheets in a stacked state, namely, the thin steel sheets during piling in the guide hole of the fixed squeeze is suppressed.

Therefore, according to the invention, there is provided the laminate dispensing method that allows the thin steel sheets inside the fixed squeeze to continue to gradually descend even during dispensing, and that eliminates concern about a lateral movement of the thin steel sheets during piling.

According to further another aspect of the invention, there is provided a laminate dispensing method including: preparing a plurality of thin steel sheets weakly joined by one of an adhesive before a curing process and a temporary crimping before a final crimping, a fixed squeeze having a guide hole that accommodates the thin steel sheets in a stacked state and that guides the thin steel sheets gradually descending at a low speed, a backup receiving the thin steel sheets in a stacked state, a backup lifting mechanism that raises and lowers the backup, a push-out mechanism that dispenses a laminate on the backup when a predetermined number of the thin steel sheets being laminated is referred to as the laminate, a movable squeeze provided below the fixed squeeze, a squeeze opening and closing mechanism that opens and closes the movable squeeze, and a control unit that controls the backup lifting mechanism and the push-out mechanism. The control unit performs control to close the movable squeeze while the thin steel sheets protruding downward from the fixed squeeze are suspended on the thin steel sheets inside the fixed squeeze by a joining action, and to dispense the laminate while the movable squeeze is closed.

According to the invention, the movable squeeze is closed while the thin steel sheets protruding downward from the fixed squeeze are suspended on the thin steel sheets inside the fixed squeeze by a joining action, and the laminate is dispensed while the movable squeeze is closed. According to this method, the descent operation of the thin steel sheets inside the fixed squeeze can be continued. In addition, a lateral movement of the thin steel sheets in a stacked state, namely, the thin steel sheets during piling in the guide hole of the fixed squeeze is suppressed.

Therefore, according to the invention, there is provided the laminate dispensing method that allows the thin steel sheets inside the fixed squeeze to continue to gradually descend even during dispensing, and that eliminates concern about a lateral movement of the thin steel sheets during piling.

According to further another aspect of the invention, there is provided a laminate dispensing device including: a fixed squeeze having a guide hole that accommodates thin steel sheets in a stacked state and that guides the thin steel sheets gradually descending at a low speed; a backup receiving the thin steel sheets in a stacked state; a backup lifting mechanism that switches the backup between a low speed and a high speed to raise and lower the backup; a push-out mechanism that dispenses a laminate on the backup when a predetermined number of the thin steel sheets being laminated is referred to as the laminate; and a control unit that controls the backup lifting mechanism and the push-out mechanism. The thin steel sheets are weakly joined by one of an adhesive before a curing process and a temporary crimping before a final crimping. A first movable squeeze and a first squeeze opening and closing mechanism that opens and closes the first movable squeeze are further provided below the fixed squeeze, and the first movable squeeze has a first guide hole having the same diameter as the guide hole when the first movable squeeze is closed. A second movable squeeze and a second squeeze opening and closing mechanism that opens and closes the second movable squeeze are further provided below the first movable squeeze. The second movable squeeze has a second guide hole having the same diameter as the first guide hole when the second movable squeeze is closed. A sum of an axial length of the first movable squeeze and an axial length of the second movable squeeze is set to be larger than a descent distance of the thin steel sheets descending from the fixed squeeze while the laminate is dispensed. The control unit performs control to start a high-speed descent of the backup once the predetermined number of thin steel sheets on the backup pass through the fixed squeeze, to close the first movable squeeze once the laminate on the backup passes through the first movable squeeze, to close the second movable squeeze once the laminate on the backup passes through the second movable squeeze, and to open the first movable squeeze and the second movable squeeze once the laminate is dispensed, then a high-speed rise of the backup starts, and the backup hits the thin steel sheets inside the second movable squeeze.

In the invention, the first movable squeeze and the second movable squeeze are provided, and the first movable squeeze and the second movable squeeze are opened and closed by the first squeeze opening and closing mechanism and the second squeeze opening and closing mechanism, so that the gradual descent operation of the thin steel sheets inside the fixed squeeze can be continued. In addition, a lateral movement of the thin steel sheets in a stacked state, namely, the thin steel sheets during piling in the guide hole of the fixed squeeze is suppressed.

Therefore, according to the invention, there is provided the laminate dispensing device that allows the thin steel sheets inside the fixed squeeze to continue to gradually descend even during dispensing, and that eliminates concern about a lateral movement of the thin steel sheets during piling.

The invention is suitable when the number of the thin steel sheets forming the laminate is large.

Once the laminate comes out of the first movable squeeze having a small height dimension, the first movable squeeze can be closed, and the protruding thin steel sheets do not fall.

### BRIEF DESCRIPTION OF THE DRAWINGS

Hereinafter, several preferred embodiments of the invention will be described in detail with reference to the accompanying drawings in which

FIGS. 1A to 1C are views describing experiments according to the invention;

FIG. 2 is a principle view of a motor core manufacturing device including a laminate dispensing device according to the invention;

FIG. 3 is a cross-sectional view of main parts of the laminate dispensing device according to the invention;

FIGS. 4A to 4D are views describing a dispensing method;

FIGS. 5A to 5C are views describing a dispensing method;

FIG. 6 is a view describing a modification example of the laminate dispensing device;

FIGS. 7A to 7C are views describing a dispensing method in the modification example; and

FIG. 8A and FIG. 8B are views describing a basic principle of a technique of the related art.

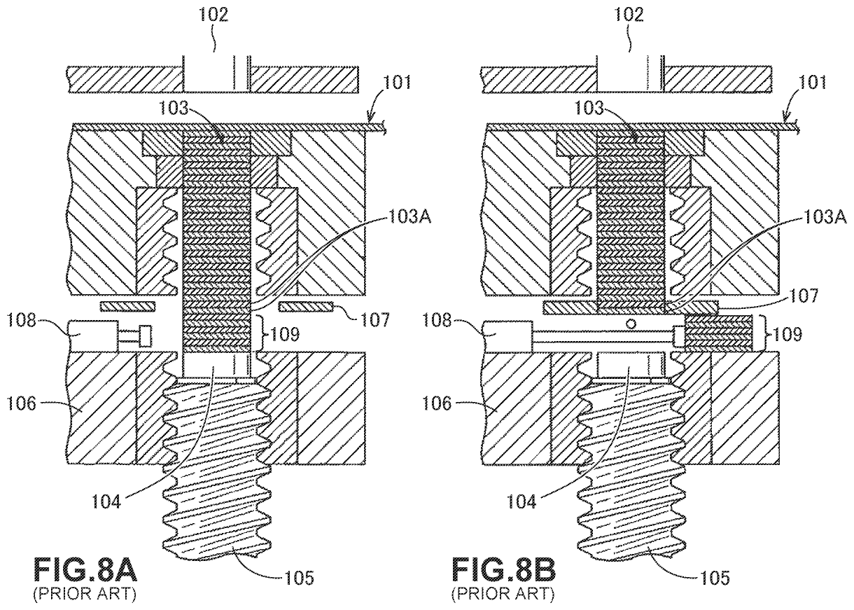

### DETAILED DESCRIPTION OF THE PREFERRED EMBODIMENTS

Embodiments of the invention will be described below with respect to the accompanying drawings. Incidentally, in the following description, “extension” means extending an overall length of a cylinder, and “retraction” means retracting the overall length of the cylinder.

A laminate dispensing device 40 according to the invention is attached to, for example, a motor core manufacturing device 10.

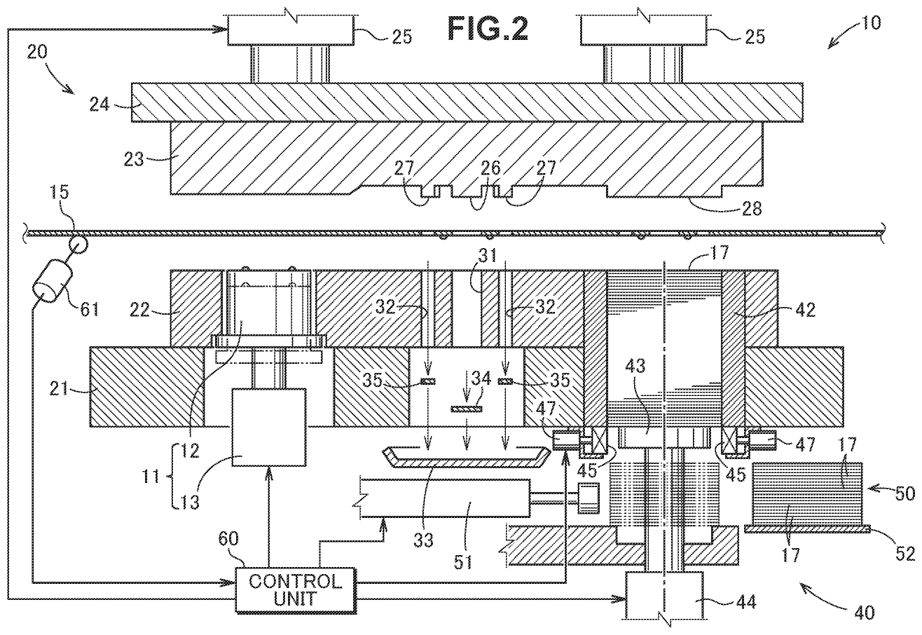

As shown in FIG. 2, the motor core manufacturing device 10 includes an adhesive application mechanism 11, a punching device 20, the laminate dispensing device 40, and a control unit 60. Hereinafter, configurations or actions of these mechanisms or devices will be described in detail.

The adhesive application mechanism 11 includes, for example, an application gun 12 having a columnar shape and a gun lifting cylinder 13 that raises and lowers the application gun 12, and applies an appropriate amount of thermosetting adhesive (or pressure-curable adhesive) to predetermined locations on a strip-shaped thin steel sheet 15.

Incidentally, in the present embodiment, the following measures are taken to prevent a thin steel sheet 17 from adhering to a backup 43.

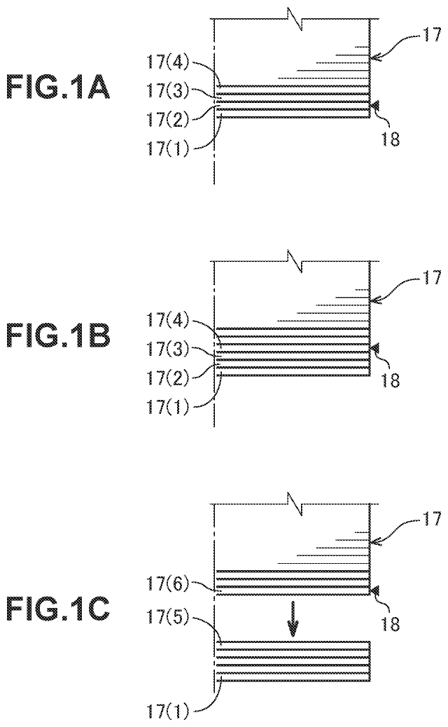

The application gun 12 descends to a position indicated by an imaginary line, and does not apply the adhesive to a thin steel sheet (FIG. 1A and reference sign 17 (1)). The application gun 12 is returned to apply the adhesive to lower surfaces of other thin steel sheets (FIG. 1A and reference sign 17 (2) to reference sign 17 (4)).

The punching device 20 includes, as basic elements, a base 21; a lower die 22 placed on the base 21; an upper die 23 disposed above the lower die 22; a press plate 24 that supports the upper die 23; and a press cylinder 25 that raises and lowers the press plate 24, and that presses the upper die 23 against the strip-shaped thin steel sheet 15 placed on the lower die 22.

A thickness of the strip-shaped thin steel sheet 15 is, for example, 0.25 mm.

Incidentally, although illustration is omitted for the sake of easy understanding, the strip-shaped thin steel sheet 15 is supported and pushed up by pins disposed to avoid the dot-shaped adhesive, such that the strip-shaped thin steel sheet 15 does not come into contact with an upper surface of the lower die 22 when the material is moved. The strip-shaped thin steel sheet 15 may be supported by a plate-shaped member so as to be pushed up more reliably. In this case, stripe-shaped recessed grooves for avoiding contact with the dot-shaped adhesive are provided in an upper surface of the plate-shaped member.

An inner peripheral punch 26, a plurality of magnet hole punches 27 surrounding the inner peripheral punch 26, and an outer peripheral punch 28 are installed on a lower surface of the upper die 23.

Scrap discharge holes 31 and 32 are provided in the lower die 22 so as to be located below the inner peripheral punch 26 and the magnet hole punches 27.

A scrap conveyor 33 is disposed below the scrap discharge holes 31 and 32, and scraps 34 and 35 generated in a punching step fall through the scrap discharge holes 31 and 32, and are discharged to the outside of the device by the scrap conveyor 33.

One thin steel sheet 17 is punched and formed by the outer peripheral punch 28. The thin steel sheet 17 descends in a state where the thin steel sheet 17 is placed on the thin steel sheet 17 that is previously punched.

At this time, the outer peripheral punch 28 repeats descending→stopping at a bottom dead point→rising→stopping at a top dead center→descending . . . . One cycle of the outer peripheral punch 28 takes approximately 0.25 seconds.

The thin steel sheets 17 descend during a period from the middle of descending (when the outer peripheral punch 28 hits the strip-shaped thin steel sheet 15) to stopping at the bottom dead point, and the thin steel sheets 17 are stopped during a period of rising→stopping at the top dead center→the middle of descending.

For this reason, the thin steel sheets 17 gradually descend in a stacked state.

Incidentally, the thin steel sheets 17 gradually descend synchronously with the operation of the outer peripheral punch 28; however, the thin steel sheets 17 may be lowered by supplying the thin steel sheets 17 using other feeder (supply mechanism), and by intermittently or continuously pushing down the thin steel sheets 17 using a push-down mechanism.

Therefore, a gradual descent includes both a descent through continuing intermittent motions and a completely continuous descent.

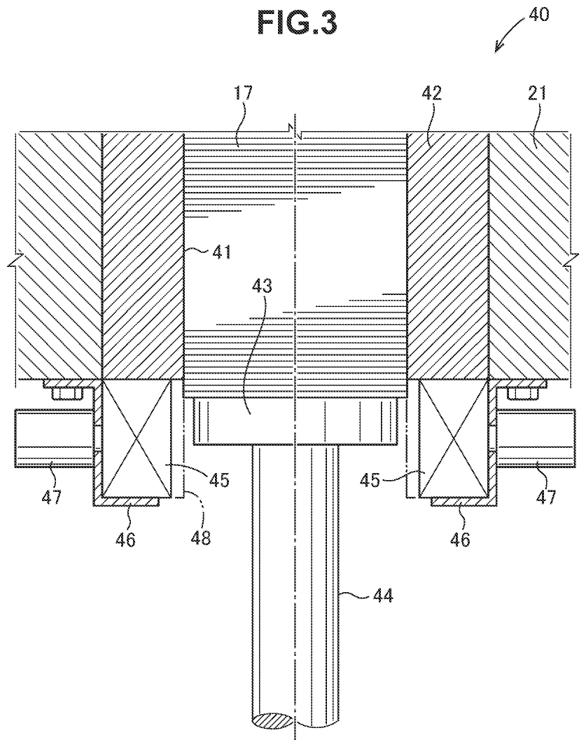

As shown in FIG. 3, the laminate dispensing device 40 includes a fixed squeeze 42 having a tubular shape and having a guide hole 41 that accommodates the thin steel sheets 17 in a stacked state and that guides the thin steel sheets 17 gradually descending at a low speed; the backup 43 having a receptacle shape and receiving the thin steel sheets 17 in a stacked state; a backup lifting mechanism 44 that switches the backup 43 between a low speed and a high speed to raise and lower the backup 43; a movable squeeze 45 disposed below the fixed squeeze 42 so as to be continuous with the fixed squeeze 42; a support fitting 46 that supports the movable squeeze 45 so as to be horizontally movable; and a squeeze opening and closing mechanism 47 that opens and closes the movable squeeze 45.

Incidentally, it is preferable that the movable squeeze 45 is disposed with a slight gap from the fixed squeeze 42. In a case where a gap is not provided, when the movable squeeze 45 is opened and closed, the movable squeeze 45 may slide against the fixed squeeze 42, so that wear is generated or the movement of the movable squeeze 45 is worsened.

By providing a gap, the generation of sliding and wear can be prevented and the movement of the movable squeeze 45 can be well maintained.

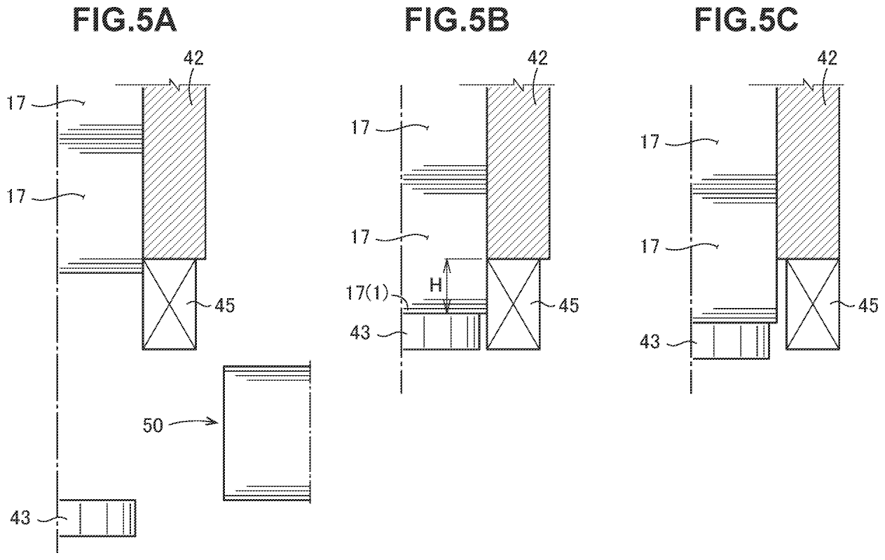

In addition, an axial length (height) of the movable squeeze 45 is set to be larger than a descent distance (FIG. 5B and reference sign H) of the thin steel sheets 17 descending from the fixed squeeze 42 while a laminate 50 is dispensed.

Further, when the movable squeeze 45 is closed, the movable squeeze 45 moves to a position indicated by an imaginary line, and a lower guide hole 48 having the same diameter as the guide hole 41 can be formed.

An air cylinder is suitable for the squeeze opening and closing mechanism 47. The air cylinder is structurally configured such that a piston stops at a forward limit position and a backward limit position. The forward limit position can be aligned with the position of the imaginary line shown in FIG. 3. When the piston is moved backward, the movable squeeze 45 opens and hits the support fitting 46 to stop. Namely, the piston stops between a forward limit and a backward limit when moving backward. Therefore, the air cylinder can control the opening and closing of the movable squeeze 45 without performing particular position control. The same applies to a hydraulic cylinder.

As described above, the squeeze opening and closing mechanism 47 can employ an air cylinder or hydraulic cylinder, and can also employ an electric cylinder. However, the squeeze opening and closing mechanism 47 may be any mechanism as long as the mechanism moves the movable squeeze 45, and may be a link or a rack and pinion using an electric motor as a driving source, and any type or structure may be employed.

As shown in FIG. 2, the backup lifting mechanism 44 generally performs a low-speed descent, a high-speed descent immediately before dispensing, a stop during dispensing, and a high-speed rise immediately after dispensing when the thin steel sheets 17 are piled (stacked) inside the fixed squeeze 42. Namely, the backup 43 is switched between a low speed and a high speed to be raised and lowered.

Rising control of the backup 43 is performed using a proximity sensor to be described later, or a method to be described next is recommended.

For example, a counter 61 monitors a movement amount of the strip-shaped thin steel sheet 15.

The control unit 60 identifies the number of the thin steel sheets 17 in the process of piling (stacking), based on the movement amount information from the counter 61. A height position of the thin steel sheets 17 descending inside the fixed squeeze 42 is calculated based on the identification.

A rising position of the backup 43 is determined based on the calculation information, and the backup 43 is raised to the determined rising position.

Since accurate position control of the backup 43 is required, a hydraulic servo cylinder that is servo-controlled is suitable for the backup lifting mechanism 44. An air servo cylinder is also suitable. In addition, an electric servo cylinder in which an electric servo motor with a built-in ball screw is used as a driving source can also be employed.

However, the backup lifting mechanism 44 may be a link or a pinion and rack using an electric servo motor as a driving source, besides a servo cylinder, and any type or structure may be employed.

In addition, as shown in FIG. 2, the laminate dispensing device 40 includes a push-out mechanism 51 that horizontally pushes out and dispenses the laminate 50, and a discharge conveyor 52 that discharges the dispensed laminate 50, when a predetermined number of the thin steel sheets 17 being laminated is referred to as the laminate 50.

The control unit 60 also controls the backup lifting mechanism 44 and the push-out mechanism 51.

An air cylinder or hydraulic cylinder is suitable for the push-out mechanism 51 since the air cylinder or hydraulic cylinder can determine the forward limit position based on a position of the discharge conveyor 52 and mechanically determine the backward limit position based on a position of the backup 43.

The push-out mechanism 51 can also employ an electric cylinder besides an air cylinder and a hydraulic cylinder. However, the push-out mechanism 51 may be any mechanism as long as the mechanism horizontally moves the laminate 50, and may be a push rod, a link, or a rack and pinion using an electric motor as a driving source, and any type or structure may be employed.

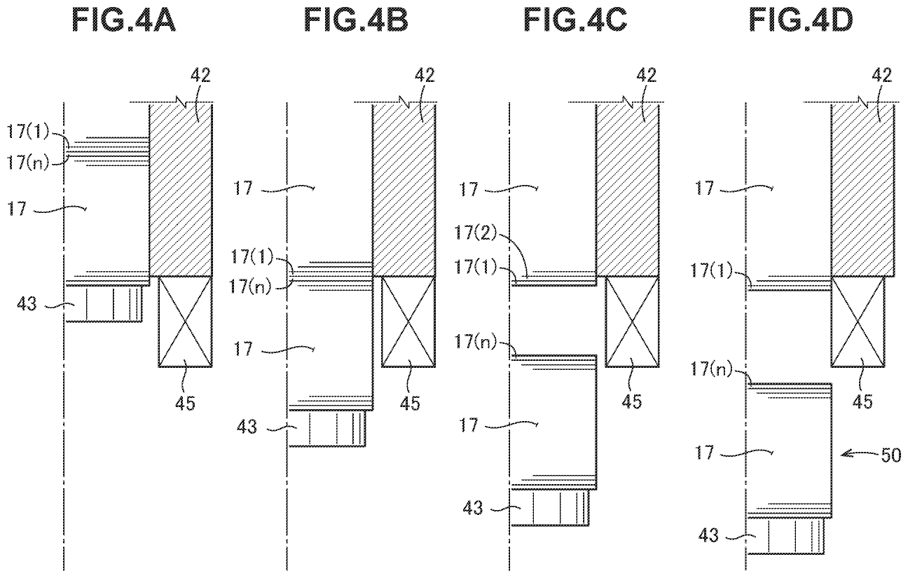

Next, a detailed operation method of the laminate dispensing device 40 will be described with reference to FIGS. 4A to 4D and FIGS. 5A to 5C.

In FIG. 4A, the movable squeeze 45 is opened. The backup 43 is located inside the movable squeeze 45. The thin steel sheets 17 gradually descend inside the fixed squeeze 42 in a stacked state.

A predetermined number n of the thin steel sheets 17 form one laminate 50. The predetermined number n is, for example, 50 to 200.

In FIG. 4B, the movable squeeze 45 is opened. A lower end of the fixed squeeze 42 is passed by a thin steel sheet 17 (n). The descent speed of the backup 43 is switched from a low speed to a high speed based on the passing information, and a high-speed descent starts.

Since the adhesive is not applied to an upper surface of the thin steel sheet 17 (n), and the adhesive is not applied to a lower surface of a thin steel sheet 17 (1) thereon, the thin steel sheet 17 (n) is separated from the thin steel sheet 17 (1).

In FIG. 4C, the movable squeeze 45 is opened. The thin steel sheet 17 (n) is still in movement inside the movable squeeze 45. During this period, the thin steel sheets 17 inside the fixed squeeze 42 continue to descend. For this reason, the lowest thin steel sheet 17 (1) of the thin steel sheets 17 inside the fixed squeeze 42 protrudes downward from the fixed squeeze 42, and a next thin steel sheet 17 (2) thereon protrudes downward from the fixed squeeze 42.

Similarly to FIG. 1A and FIG. 1B, the adhesive is interposed between the thin steel sheet 17 (1) and the thin steel sheet 17 (2) thereon. Due to the surface tension of the adhesive, the thin steel sheet 17 (1) adheres to the thin steel sheet 17 (2) and does not fall.

In FIG. 4D, once the thin steel sheet 17 (n) passes the lower end of the movable squeeze 45, the movable squeeze 45 is closed based on the passing information.

Since the thin steel sheets 17 inside the fixed squeeze 42 and the movable squeeze 45 are lightly stopped by the fixed squeeze 42 and the movable squeeze 45 due to friction, the thin steel sheets 17 do not fall. In this state, the thin steel sheets 17 continue to gradually descend.

The backup 43 descends to a lowest position (dispensable position).

In FIG. 5A, the laminate 50 is dispensed from the backup 43. The movable squeeze 45 is closed. During this period, the thin steel sheets 17 inside the fixed squeeze 42 and the movable squeeze 45 continue to descend.

The push-out mechanism (FIG. 2 and reference sign 51) retracts, and next, the backup lifting mechanism (FIG. 2 and reference sign 44) extends at high speed. Namely, a high-speed rise of the backup 43 starts based on the retraction information of the push-out mechanism. During this period as well, the thin steel sheets 17 inside the fixed squeeze 42 and the movable squeeze 45 continue to gradually descend.

In FIG. 5B, the movable squeeze 45 is closed. The backup lifting mechanism (FIG. 2 and reference sign 44) stops at the time that the backup 43 hits the thin steel sheet 17 (1) inside the movable squeeze 45.

Specifically, the backup 43 has a double-layered structure, and the proximity sensor is interposed therebetween. When the backup 43 hits the thin steel sheet 17 (1), double-layered sheets come into contact with (or approach) the thin steel sheet 17 (1), and the contact is detected by the proximity sensor. The proximity sensor may be a load cell.

The control unit (FIG. 2 and reference sign 60) causes the backup lifting mechanism (FIG. 2 and reference sign 44) to stop, based on the detection information of the proximity sensor or load cell.

Alternatively, the control unit (FIG. 2 and reference sign 60) controls the backup lifting mechanism (FIG. 2 and reference sign 44) to perform position control of the backup 43 by calculating the number of the thin steel sheets 17 inside the fixed squeeze 42 and the movable squeeze 45 from information from the counter (FIG. 2 and reference sign 61), by calculating a height of the lowest thin steel sheet 17 (1), and by calculating a height at which the backup 43 comes into contact with the lowest thin steel sheet 17 (1).

Several tens of the thin steel sheets 17 protrude from the fixed squeeze 42 at the time that the backup 43 hits the thin steel sheet 17 (1), but the thin steel sheets 17 do not fall due to the existence of the movable squeeze 45. Namely, the closed movable squeeze 45 plays a role of preventing the falling of the several tens of thin steel sheets 17 protruding from the fixed squeeze 42.

For this reason, the axial length (height) of the movable squeeze 45 is set to be larger than the descent distance H of the thin steel sheets 17 during a transition of FIG. 4C→FIG. 4D→FIG. 5A→FIG. 5B.

The movable squeeze 45 is opened based on the information that the backup 43 hits the thin steel sheet 17 (1). In parallel, a low-speed descent of the backup 43 starts (resumes).

In FIG. 5C, the movable squeeze 45 is opened, and the low-speed descent of the backup 43 continues synchronously with the thin steel sheets 17 in a stacked state.

FIG. 5C shows an intermediate operation between FIG. 4A and FIG. 4B.

Hereinafter, FIG. 4B→FIG. 4C→FIG. 4D→FIG. 5A→FIG. 5B→FIG. 5C→FIG. 4B . . . are repeated.

The operation method described with reference to FIGS. 4A to 4D and FIGS. 5A to 5C can be summarized as follows.

The control unit 60 causes the movable squeeze 45 to be opened, and causes a high-speed descent of the backup 43 to start (FIG. 4C) once a predetermined number of the thin steel sheets 17 on the backup 43 pass through the fixed squeeze 42 (FIG. 4B). Once the laminate 50 on the backup 43 passes through the movable squeeze 45, the movable squeeze 45 is closed (FIG. 4D).

The laminate 50 is dispensed (FIG. 5A), then a high-speed rise of the backup 43 starts, and the backup 43 hits the thin steel sheet 17 (1) inside the movable squeeze 45 (FIG. 5B).

Once the backup 43 hits the thin steel sheet 17 (1), the movable squeeze 45 is opened (FIG. 5C).

A series of these operations are controlled by the control unit 60. As a result, as shown in FIGS. 4A to 4D and FIGS. 5A to 5C, by dispensing the laminate 50 without stopping the thin steel sheets 17 gradually descending inside the fixed squeeze 42, the dispensing amount can be increased and productivity can be increased.

Alternatively, the method according to the invention can be summarized as follows.

The control unit 60 causes the movable squeeze 45 to be closed while the thin steel sheets 17 protruding downward from the fixed squeeze 42 are suspended on the thin steel sheets 17 inside the fixed squeeze 42 by a joining action (FIG. 4C and FIG. 4D), and causes the laminate 50 to be dispensed while the movable squeeze 45 is closed (FIG. 5A).

As a result, as shown in FIGS. 4A to 4D and FIGS. 5A to 5C, by dispensing the laminate 50 without stopping the thin steel sheets 17 gradually descending inside the fixed squeeze 42, the dispensing amount can be increased and productivity can be increased.

Incidentally, as shown in FIG. 4D, after all the thin steel sheets 17 equivalent to the laminate 50 come out of the movable squeeze 45, the movable squeeze 45 is closed.

Compared to when n is 50, in FIG. 4C, the number of the thin steel sheets 17 protruding from the fixed squeeze 42 is four times when n is 200.

Since the press speed (shots per minute) is high and the descent speed of the backup 43 is slow, as the number of the protruding thin steel sheets 17 is increased, the risk that the dead weight of the protruding thin steel sheets 17 increases and the increased dead weight exceeds the surface tension of the adhesive increases.

In addition, depending on the type of an adhesive and the structure of a temporary crimping, the risk that a joining force is weaker than expected and the increased dead weight exceeds the joining force increases.

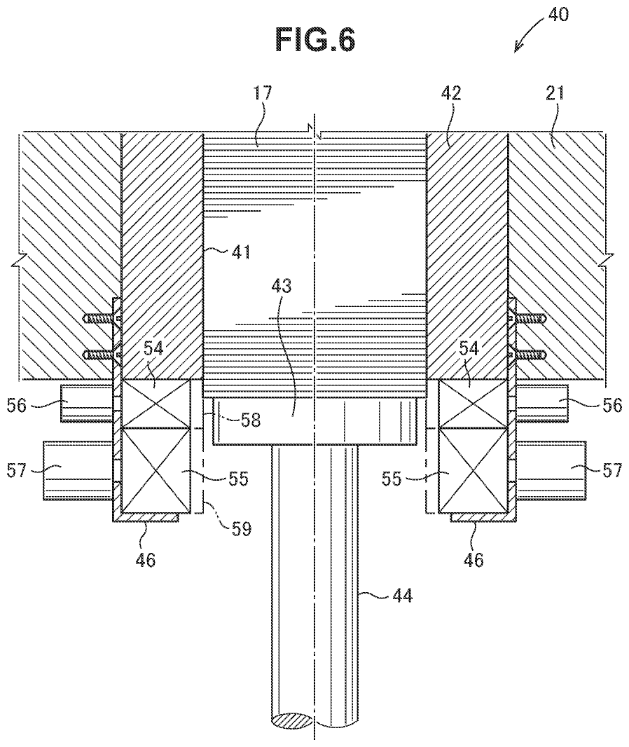

A modification example capable of eliminating these risks will be described with reference to FIG. 6.

In the modification example, the movable squeeze 45 in FIG. 3 is divided up and down by a horizontal line. Namely, as shown in FIG. 6, the movable squeeze 45 is divided into a first movable squeeze 54 disposed below the fixed squeeze 42 with a slight gap therebetween, and a second movable squeeze 55 disposed below the first movable squeeze 54 with a slight gap therebetween.

A height of the first movable squeeze 54 is 0.2 to 0.5 times the height of the movable squeeze 45, and a height of the second movable squeeze 55 is 0.5 to 0.8 times the height of the movable squeeze 45.

In order to open and close the first movable squeeze 54 and the second movable squeeze 55 independently of each other, a first squeeze opening and closing mechanism 56 is connected to the first movable squeeze 54, and a second squeeze opening and closing mechanism 57 is connected to the second movable squeeze 55.

When the first movable squeeze 54 is closed, a first guide hole 58 having the same diameter as the guide hole 41 can be formed.

Similarly, when the second movable squeeze 55 is closed, a second guide hole 59 having the same diameter as the first guide hole 58 can be formed.

Since other configurations shown in FIG. 6 are the same as those in FIG. 3, the reference signs in FIG. 3 are used and detailed description of the structures will be omitted.

Next, actions of the modification example will be described.

The difference is that the movable squeeze 45 is divided into the first movable squeeze 54 and the second movable squeeze 55, but in FIG. 4A, FIG. 4B, FIG. 5B, and FIG. 5C, the first movable squeeze 54 and the second movable squeeze 55 are located together at an open position or a closed position, so that actions are the same.

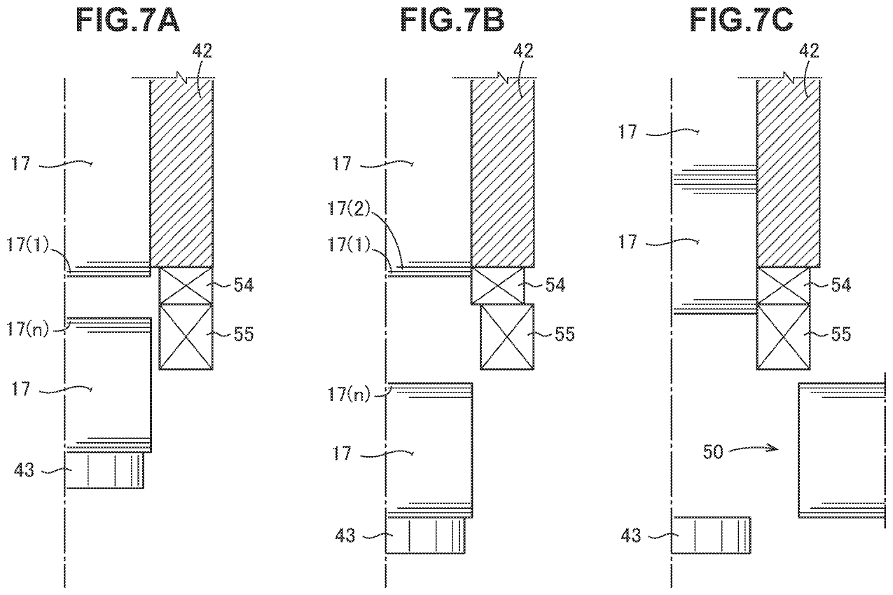

Since actions are different in FIG. 4C, FIG. 4D, and FIG. 5A, the different actions will be described with reference to FIGS. 7A to 7C.

In FIG. 7A, the first movable squeeze 54 and the second movable squeeze 55 are opened. The thin steel sheets 17 inside the fixed squeeze 42 continue to descend.

Once the thin steel sheet 17 (n) passes a lower end of the first movable squeeze 54, the first movable squeeze 54 is closed based on the passing information.

In FIG. 7B, the first movable squeeze 54 is closed and the second movable squeeze 55 is opened.

The thin steel sheets 17 (1) and 17 (2) protruding from the fixed squeeze 42 continue to descend while being guided by the first movable squeeze 54.

Once the thin steel sheet 17 (n) passes a lower end of the second movable squeeze 55, the second movable squeeze 55 is closed based on the passing information.

The backup 43 descends to the lowest position (dispensable position).

In FIG. 7C, the laminate 50 is dispensed from the backup 43. The first movable squeeze 54 and the second movable squeeze 55 are closed. During this period, the thin steel sheets 17 inside the fixed squeeze 42, the first movable squeeze 54, and the second movable squeeze 55 continue to descend.

The push-out mechanism (FIG. 2 and reference sign 51) retracts, and next, the backup lifting mechanism (FIG. 2 and reference sign 44) extends at high speed. Namely, a high-speed rise of the backup 43 starts based on the retraction information of the push-out mechanism. During this period, the thin steel sheets 17 inside the fixed squeeze 42, the first movable squeeze 54, and the second movable squeeze 55 continue to gradually descend. Hereinafter, the operation continues in FIG. 5B.

Namely, in the modification example, FIG. 4B→FIG. 7A→FIG. 7B→FIG. 7C→FIG. 5B→FIG. 5C→FIG. 4B→FIG. 7A . . . are repeated.

In the modification example, immediately after the thin steel sheet 17 (n) passes through the first movable squeeze 54, the first movable squeeze 54 can be closed.

Therefore, the modification example has an advantage that the number of the protruding thin steel sheets 17 that may fall due to the dead weight, which is a concern, can be reduced.

In the modification example, the movable squeeze 45 is divided up and down into two pieces, but may be divided into three or more pieces if necessary.

Incidentally, the laminate dispensing technique of the invention is suitable for the motor core manufacturing technique, but can be applied to other mechanisms for laminating workpieces and other mechanisms for dispensing workpieces, and applications are not particularly limited.

In addition, a thin steel sheet and a thin steel sheet thereon are weakly joined by a thermosetting adhesive, pressure-curable adhesive, or temporary crimping; however, the joining may be performed using antirust resin, antirust oil, decorative paint, or others, and in short, any joining method may be used as long as the joining method exhibits a weak joining action during dispensing of the laminate.

Crimping includes a case where the sheet thickness is as very thin as 0.20 mm or less.

The adhesive may be an anaerobic adhesive. This is because even the anaerobic adhesive does not completely cure during lamination. In addition, the adhesive may contain a delayed curing accelerator such that the adhesive does not completely cure during lamination.

[Industrial Applicability]

The laminate dispensing technique of the invention is suitable for the motor core manufacturing technique.

What is claimed is:

1. A laminate dispensing device comprising:
a fixed squeeze having a guide hole that accommodates thin steel sheets in a stacked state and that guides the thin steel sheets gradually descending at a low speed;
a backup receiving the thin steel sheets in a stacked state;
a backup lifting mechanism that switches the backup between a low speed and a high speed to raise and lower the backup;
a push-out mechanism that dispenses a laminate on the backup when a predetermined number of the thin steel sheets being laminated is referred to as the laminate; and
a control unit that controls the backup lifting mechanism and the push-out mechanism,
wherein the thin steel sheets are weakly joined by one of an adhesive before a curing process and a temporary crimping before a final crimping,
a movable squeeze and a squeeze opening and closing mechanism that opens and closes the movable squeeze are further provided below the fixed squeeze,
the movable squeeze has a lower guide hole having the same diameter as the guide hole when the movable squeeze is closed,
an axial length of the movable squeeze is set to be larger than a descent distance of the thin steel sheets descending from the fixed squeeze while the laminate is dispensed, and
the control unit performs control to start a high-speed descent of the backup once the predetermined number of thin steel sheets on the backup pass through the fixed squeeze, to close the movable squeeze once the laminate on the backup passes through the movable squeeze, and to open the movable squeeze once the laminate is dispensed, then a high-speed rise of the backup starts, and the backup hits the thin steel sheets inside the movable squeeze.

2. A laminate dispensing method comprising:
preparing a plurality of thin steel sheets weakly joined by one of an adhesive before a curing process and a temporary crimping before a final crimping, a fixed squeeze having a guide hole that accommodates the thin steel sheets in a stacked state and that guides the thin steel sheets gradually descending at a low speed, a backup receiving the thin steel sheets in a stacked state, a backup lifting mechanism that switches the backup between a low speed and a high speed to raise and lower the backup, a push-out mechanism that dispenses a laminate on the backup when a predetermined number of the thin steel sheets being laminated is referred to as the laminate, a movable squeeze provided below the fixed squeeze, and a squeeze opening and closing mechanism that opens and closes the movable squeeze; and
dispensing the laminate while continuing the descent of the thin steel sheets inside the fixed squeeze, by starting a high-speed descent of the backup once the predetermined number of thin steel sheets on the backup pass through the fixed squeeze, by closing the movable squeeze once the laminate on the backup passes through the movable squeeze, and by opening the movable squeeze once the laminate is dispensed, then a high-speed rise of the backup starts, and the backup hits the thin steel sheets inside the movable squeeze.

3. A laminate dispensing method comprising:
preparing a plurality of thin steel sheets weakly joined by one of an adhesive before a curing process and a temporary crimping before a final crimping, a fixed squeeze having a guide hole that accommodates the thin steel sheets in a stacked state and that guides the thin steel sheets gradually descending at a low speed, a backup receiving the thin steel sheets in a stacked state, a backup lifting mechanism that raises and lowers the backup, a push-out mechanism that dispenses a laminate on the backup when a predetermined number of the thin steel sheets being laminated is referred to as the laminate, a movable squeeze provided below the fixed squeeze, a squeeze opening and closing mechanism that opens and closes the movable squeeze, and a control unit that controls the backup lifting mechanism and the push-out mechanism,
wherein the control unit performs control to close the movable squeeze while the thin steel sheets protruding downward from the fixed squeeze are suspended on the thin steel sheets inside the fixed squeeze by a joining action, and to dispense the laminate while the movable squeeze is closed.

4. A laminate dispensing device comprising:
a fixed squeeze having a guide hole that accommodates thin steel sheets in a stacked state and that guides the thin steel sheets gradually descending at a low speed;
a backup receiving the thin steel sheets in a stacked state;
a backup lifting mechanism that switches the backup between a low speed and a high speed to raise and lower the backup;
a push-out mechanism that dispenses a laminate on the backup when a predetermined number of the thin steel sheets being laminated is referred to as the laminate; and
a control unit that controls the backup lifting mechanism and the push-out mechanism,
wherein the thin steel sheets are weakly joined by one of an adhesive before a curing process and a temporary crimping before a final crimping,
a first movable squeeze and a first squeeze opening and closing mechanism that opens and closes the first movable squeeze are further provided below the fixed squeeze, and the first movable squeeze has a first guide hole having the same diameter as the guide hole when the first movable squeeze is closed,
a second movable squeeze and a second squeeze opening and closing mechanism that opens and closes the second movable squeeze are further provided below the first movable squeeze,
the second movable squeeze has a second guide hole having the same diameter as the first guide hole when the second movable squeeze is closed,
a sum of an axial length of the first movable squeeze and an axial length of the second movable squeeze is set to be larger than a descent distance of the thin steel sheets descending from the fixed squeeze while the laminate is dispensed, and
the control unit performs control to start a high-speed descent of the backup once the predetermined number of thin steel sheets on the backup pass through the fixed squeeze, to close the first movable squeeze once the laminate on the backup passes through the first movable squeeze, to close the second movable squeeze once the laminate on the backup passes through the second movable squeeze, and to open the first movable squeeze and the second movable squeeze once the laminate is dispensed, then a high-speed rise of the backup starts, and the backup hits the thin steel sheets inside the second movable squeeze.
